(19) United States
(12) Patent Application Publication
(10) Pub. No.: US 2012/0113826 A1
(43) Pub. Date: May 10, 2012

(54) Idle Interval Generation in Telecommunication Systems

(76) Inventors: Heng Zhou, San Diego, CA (US); Tom Chin, San Diego, CA (US); Shan Qing, San Diego, CA (US)

(21) Appl. No.: 12/941,872

(22) Filed: Nov. 8, 2010

(51) Int. Cl. H04W 72/04; H04W 24/00

(52) U.S. Cl. 370/252; 370/336; 370/335

(57) ABSTRACT

In certain wireless communications systems, such as TD-SCDMA, frames are divided into sections allocated for various communication purposes such as uplink and downlink transmissions. In such schemes, there may be no mechanism to generate gaps for a UE to employ for non-allocated purposes, such as inter-frequency or inter-RAT measurement. To generate gaps for such purposes the UE may employ rate-matching techniques to take certain allocated time slots for the UE and reserve them for inter-RAT measurement or other purposes. The rate-matching techniques generate unconfigured slots.

### BACKGROUND

1. Field

Aspects of the present disclosure relate generally to wireless communication systems, and more particularly, to idle interval generation in telecommunication systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the disclosure a method of wireless communication includes determining a number of resource elements allocated to a user equipment (UE). The method also includes determining how many resource elements are within each uplink time slot in order to determine a number of time slots allocated to the UE. The method further includes determining how many allocated time slots to release in order to determine a number of transmit time slots. The number of transmit time slots is fewer than the number of allocated time slots. Still further, the method includes selecting data with a size that fits within resource elements of only the transmit time slots. The method also includes transmitting during the transmit time slots, and allocating released time slots to the UE for a purpose other than uplink transmission with a serving base station.

In another aspect of the disclosure, a system is configured for wireless communication. The system includes means for determining a number of resource elements allocated to a user equipment (UE). The system also includes means for determining how many resource elements are within each uplink time slot in order to determine a number of time slots allocated to the UE. The system further includes means for determining how many allocated time slots to release in order to determine a number of transmit time slots, the number of transmit time slots being fewer than the number of allocated time slots. Still further, the system includes means for selecting data with a size that fits within resource elements of only the transmit time slots. The method also includes means for transmitting during the transmit time slots, and means for allocating released time slots to the UE for a purpose other than uplink transmission with a serving base station.

In another aspect of the disclosure, a computer program product includes a computer-readable medium having program code recorded thereon. The program code includes code to determine a number of resource elements allocated to a user equipment (UE). The program code also includes code to determine how many resource elements are within each uplink time slot in order to determine a number of time slots allocated to the UE. The program code further includes code to determine how many allocated time slots to release in order to determine a number of transmit time slots, the number of transmit time slots being fewer than the number of allocated time slots. Still further, the program code includes code to select data with a size that fits within resource elements of only the transmit time slots. The program code also includes code to transmit during the transmit time slots, and code to allocate released time slots to the UE for a purpose other than uplink transmission with a serving base station.

In another aspect of the disclosure, an apparatus for wireless communication includes at least one processor and a memory coupled to the processor. The processor is configured to determine a number of resource elements allocated to a user equipment (UE). The processor is also configured to determine how many resource elements are within each uplink time slot in order to determine a number of time slots allocated to the UE. The processor is further configured to determine how many allocated time slots to release in order to determine a number of transmit time slots. The number of transmit time slots is fewer than the number of allocated time slots. Still further the processor is configured to select data with a size that fits within resource elements of only the transmit time slots. The processor is also configured to transmit during the transmit time slots, and to allocate released time slots to the UE for a purpose other than uplink transmission with a serving base station.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram conceptually illustrating an example of a frame structure in a telecommunications system.

FIG. 5 is a block diagram conceptually illustrating an example of a frame structure in a telecommunications system.

FIG. 6 is a block diagram conceptually illustrating an example of a frame structure in a telecommunications system according to one aspect of the present disclosure.

FIG. 7 is a block diagram conceptually illustrating an example of a frame structure in a telecommunications system according to one aspect of the present disclosure.

FIG. 8 is a functional block diagram conceptually illustrating example blocks executed to implement one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

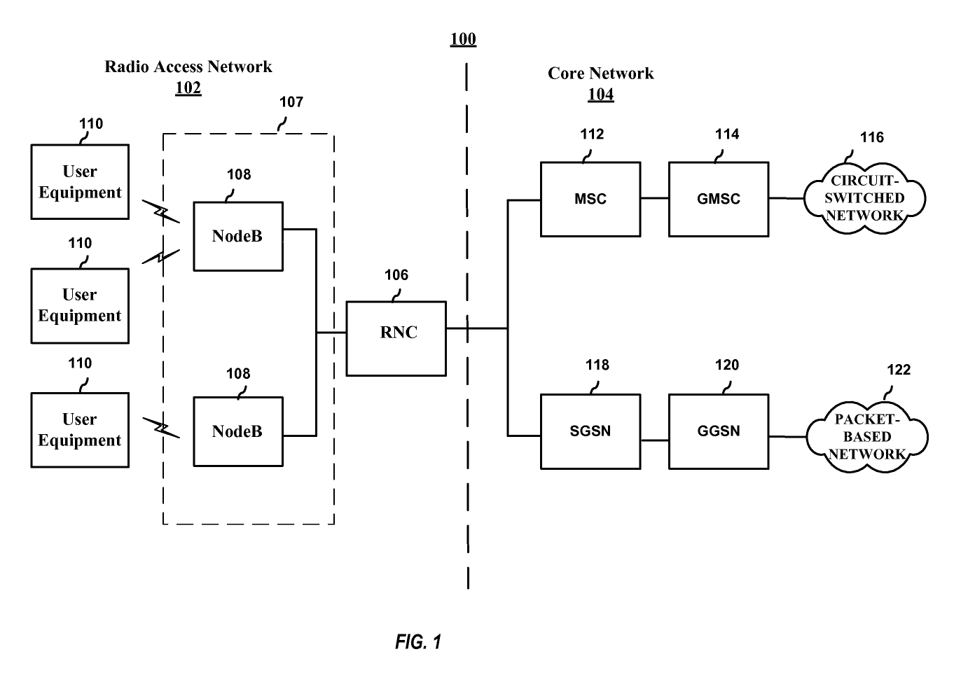

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs), such as an RNS 107, each controlled by a Radio Network Controller (RNC), such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces, such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

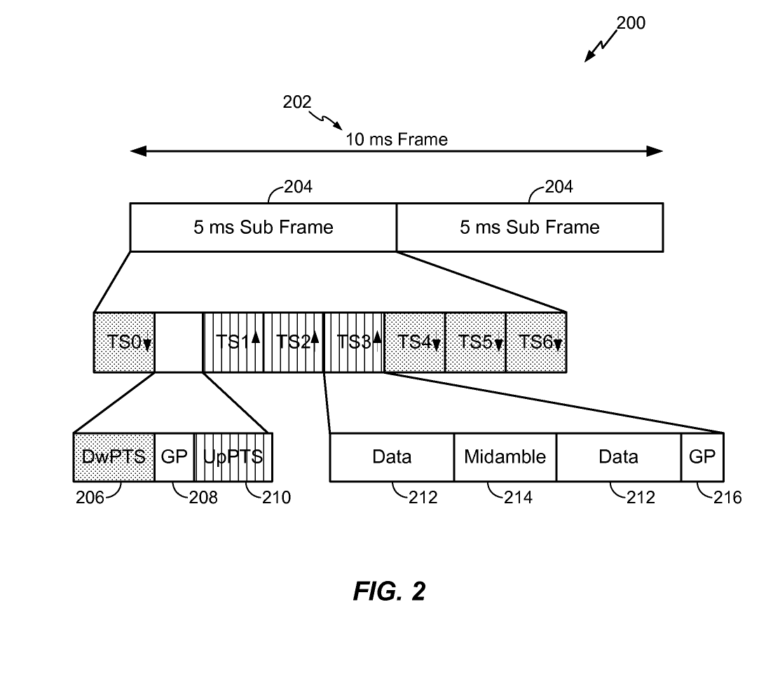

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206 (also referred to herein as the downlink pilot channel (DwPCH)), a guard period (GP) 208, and an uplink pilot time slot (UpPTS) 210 (also referred to herein as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

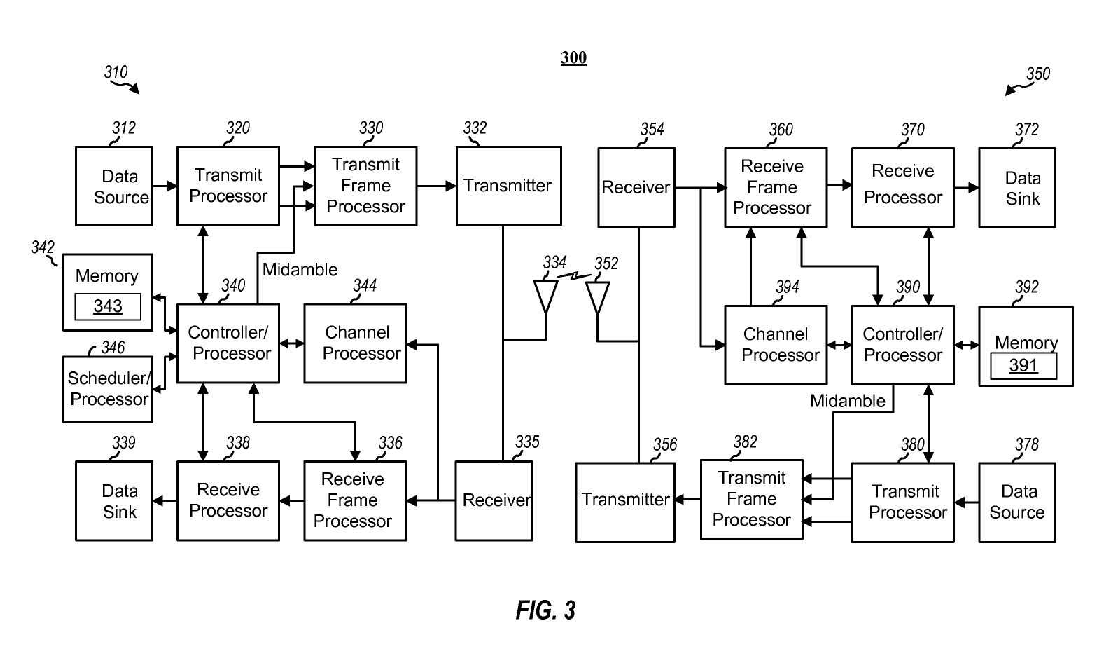

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard, pointing device, track wheel, and the like). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the smart antennas 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor 340, respectively. If some of the frames were unsuccessfully decoded by the receive processor 338, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a gap generation module 391 that, when executed by the controller/processor 390, allows the UE 350 to generate idle intervals for the UE. A scheduler/processor 346 at the node B 310 may be used to allocate resources to the UEs and schedule downlink and/or uplink transmissions for the UEs, which may be used by the gap generation module 391, the controller/processor 390, the transmit processor 380, or the transmit frame processor 382 to generate gaps as described below.

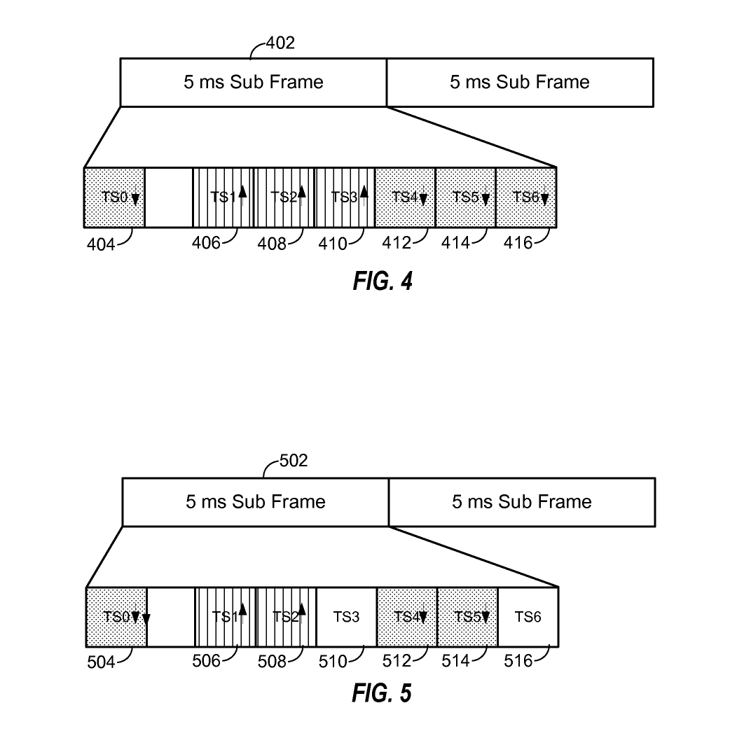

In certain time-division wireless communication systems, frames are divided into sections which are allocated for various communication purposes. For example, in a TD-SCDMA system, a subframe 402 is divided as shown in FIG. 4. Time slots (TS) 0, 4, 5, and 6 are designated as downlink timeslots as indicated by the shading and down arrows of blocks 404, 412, 414, and 416. Time slots 1, 2, and 3 are designated as uplink timeslots as indicated by the horizontal lines and up arrows of blocks 406, 408, and 410.

In TD-SCDMA systems employing this frame structure, there is no compressed mode or similar mechanism defined to generate gaps for a UE to employ during inter-frequency or inter-radio access technology (inter-RAT) measurement when the UE is in CELL_DCH state, having been assigned a dedicated physical channel (DPCH). In order to perform inter-frequency or inter-RAT measurement the UE can only use the idle interval comprising unconfigured slots, namely the period in which slots are not allocated to the UE for either downlink (DL) or uplink (UL). In the case of the frame structure of FIG. 4, all slots have an assigned channel and the UE may not have an opportunity to perform inter-frequency or inter-RAT measurement.

In certain situations sub frame slots may be unassigned, as shown in FIG. 5. In subframe 502, time slots TS3 510 and TS6 516 are unassigned. There the UE may use slots 3 and 6 for inter-frequency or inter-RAT measurement. Because the intervals for measurement are one slot long, however, they may not be long enough to meet the UE's measurement requirements.

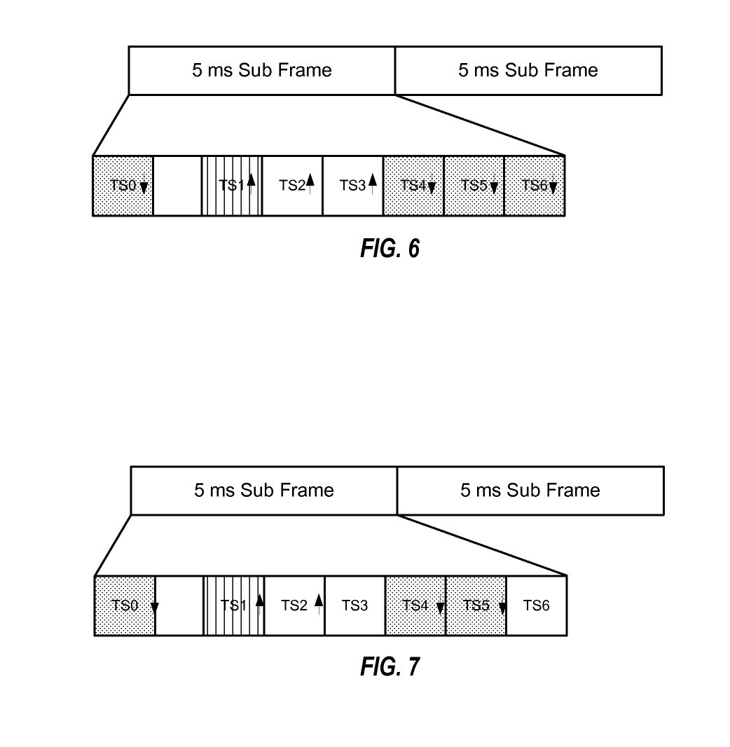

In order to meet inter-frequency or inter-RAT measurement in systems such as TD-SCDMA, finding more or larger idle intervals is important in UE measurement design and implementation. The present disclosure provides ways to generate new or larger idle intervals from assigned uplink slots. In the gap generation manner described herein, a UE may be given a new idle interval during its assigned uplink timeslots 2 and 3 as shown in FIG. 6 or a larger idle interval combining assigned uplink timeslot 2 with unassigned timeslot 3 as shown in FIG. 7.

If the amount of uplink data being transmitted by a UE is less than the allocated uplink channel capacity, the UE may not use all the assigned uplink slots, which results in leftover unused slots. These unused slots can be used to create a new or larger idle interval.

A Transport Format (TF) is defined as the number of transport blocks (numBlock) and transport block size (blockSize). So the data size for the Transport Format is equal to numBlock*blockSize. A Transport Channel (TrCH) is configured by a number of transport formats indexed by a Transport Format Index. A group of TrCHs are multiplexed into a physical layer channel called a Coded Composite Transport Channel (CCTrCH). The multiplexed transport channels have their corresponding transport formats. For example, a CCTrCH may have two transport channels, TrCH#1 and TrCH#2. TrCH#1 has 4 transport formats, TF_{1,1}, TF_{1,2}, TF_{1,3}, TF_{1,4}. TrCH#2 has 2 transport formats, TF_{2,1}, TF_{2,2}. A Transport Format Combination (TFC) identifies the TrCH and its associated format. A TFC Set is a set of TFCs that will make up the CCTrCH. Each TFC in a TFC Set is indexed by a Transport Format Combination Index.

In particular, TD-SCDMA rate matching may generate unused time slots. In every radio frame (10 ms), a rate-matching block will collect a pre-rate matching radio frame from each transport channel (TrCH), and then puncture (remove) or repeat bits of pre-rate match frames to fit the output into the allocated physical channel capacity. In the present disclosure, the UE may incorporate its need to perform inter-RAT measurement into its rate-matching procedures so a gap sufficient for inter-RAT measurement is incorporated into the UE's rate-matching calculations. Thus, the UE punctures additional bits, and groups data transmission, to create a sufficient idle period for the UE to perform inter-RAT measurement.

For each radio frame, uplink rate matching performs three steps. First, physical channel capacity is selected based on the current Transport Format Combination (TFC). The selection determines how much physical channel capacity (considering the physical channels and their spreading factors) is to be used from the available physical channel capacity. Second, physical channel capacity is allocated among the transport channels. Third, rate matching parameters are calculated and executed. The first step, physical channel capacity selection, may be executed in a way which provides new or longer idle intervals for use in inter-frequency or inter-RAT measurement.

In accordance with 3GPP standard 25.222, part 4.2.7.1, the set N_{data} is defined as available physical channel capacity set in ascending order.

N_{data}={U_{1,16}, U_{1,8}, . . . , U_{1,S1min}, U_{1,S1min}+U_{2,16}, U_{1,S1min}+U_{2,8}, . . . , U_{1,S1min}+U_{2,S2min}, . . . , U_{1,S1min}+U_{2,S2min}+ . . . +U_{Pmax-1,(SPmax-1)min}+U_{Pmax,16}, U_{1,S1min}+U_{2,S2min}+ . . . +U_{Pmax-1,(SPmax-1)min}+U_{Pmax,8}, . . . , U_{1,S1min}+U_{2,S2min}+ . . . +U_{Pmax-1,(SPmax-1)min}+U_{Pmax, (SPmax)min}}

where
Pₘₐₓ: the number of physical channels, 1≦p≦Pₘₐₓ; p is a physical channel sequence number and described after.
S_{Pmin}: the minimum spreading factor for physical channel p. S_{Pmin} can be {16, 8, 4, 2, 1}. S₁ₘᵢₙ denotes the minimum spreading factor for physical channel 1. The physical channel 1 can have SP={16, 8, . . . , S₁ₘᵢₙ}.
U_{P,Sp}: the maximum number of data bits for physical channel p with spreading factor S_{P}. U_{1,16} is the maximum data on physical channel 1 with spreading factor 16. U_{1,S1min} is the maximum data on physical channel 1 with its minimum spreading factor S1ₘᵢₙ. U_{Pmax, (SPmax)min} is the maximum data on physical channel Pₘₐₓ with its minimum spreading factor S_{(Pmax)min}.
   For Pₘₐₓ physical channels, they are ordered by:
The physical channel with lower slot number will be before the one with higher slot number.
Within a slot, the physical channel with lower minimum spreading factor will be before the one with higher minimum spreading factor.
If two physical channels are in the same slot and have the same minimum spreading factor, the one having a lower channel code index will be before the channel with higher channel code index.
   After Pₘₐₓ physical channels are ordered, the physical channel sequence number (1≦p≦Pₘₐₓ) is assigned to each physical channel based on the order.

For each radio frame, its TFC is known and implies how much data will be transmitted in the frame. Suppose the current TFC is TFCⱼ. Based on 3GPP standard 25.222, Section 4.2.7.1, the SET₁ is defined as the physical channel capacity set which meets the amount of data in the current frame.

SET₁={n_{data} such that

$$( {min}_{1 \leq y \leq I} \{ R {M}_{y} \} ) \times {n}_{data} - P L \times {\sum }_{x = 1}^{I} R {M}_{x} \times {N}_{x , j}$$

is non negative}

where
RM_{y}: semi-static rate matching parameter for TrCH y.
I: the maximum number of TrCHs.
n_{data} an element in N_{data} set.
PL: semi-static puncturing limit.
N_{x,j}: data size of TrCH x on TFCⱼ
n_{data,j}=min SET₁
n_{data,j} is the minimum physical channel capacity needed for data in the current radio frame.

With n_{data,j}, a UE can determine the corresponding physical channels and their spreading factors based on the set N_{data}. Therefore, a UE can know how many uplink slots are used for the frame, and what uplink slots are not used.

In one aspect, if a UE does not consume all uplink configured slots (such as when less data exists or a lower transmit power is allowed), the unused uplink slots may be set aside as a gap or combined (if nearby slots are not configured for the UE) to form a bigger gap and allocated for measurement purposes.

In another aspect, a UE can use a physical channel capacity selection algorithm to adjust the used slots based on the UE's need, while unused slots become a gap, or increase a gap if the following slots are not used for downlink for the UE.

For example, in a certain situation a UE may be allocated three time slots by a base station, but may need two slots for inter-RAT measurement, leaving only one slot for transmission. The UE may determine which allocated physical channels are in the transmission slot. It may then run the channel selection algorithm to determine which TFC best fits the physical channel in the transmit slot. That TFC will be selected for transmission in the transmit slot while the remaining slots will be used by the UE for inter-RAT measurement.

For each TFC, the transport format of each transport channel is known, so the total data size of the TFC is known. In time division duplexing, 3GPP physical channel use order is based on the slot order. Proper TFC selection may result in selecting fewer physical channels and a fewer number of slots. Two methods of TFC selection may control the number of uplink slots taken by the UE. The physical channel capacity selection algorithm is based on the current TFC. TFC selection is based on two factors, maximum allowed transmit power by the UE and the amount of data requested to transmit by the UE. The maximum allowed transmit power is set by a function describing a UE specific relationship between power and allowed TFC Set. If power is limited, the data rate is limited and the data size is limited, and thus only a TFC within a certain data size is allowed. Thus the maximum allowed transmit power is tied to available physical channel capacity and managed by eliminating larger data size TFCs. Selection of a lower channel capacity allows unused capacity to be allocated for inter-RAT measurement, or other purposes. Once the number of slots needed for inter-RAT measurement is known, power control or data size selection may free time slots to be used for measurement.

The UE may manipulate gaps in the following ways. First, the UE may consider the allowed maximum used slots during TFC selection to eliminate large data size TFCs from the TFC Set. Thus, after executing the physical channel capacity selection algorithm, and TFC elimination, the TFC Set will contain only TFCs resulting in the used slots not exceeding the maximum used slots.

Second, if the UE requests less data to transmit, the UE will not consume all uplink slots allocated to the UE. This approach can be combined with the above such that the UE eliminates all large size TFCs and finds the maximum data size TFC in the remaining TFC Set. This data size is the limit on the amount of data to be allowed to transmit. If the UE does not request data transmission larger than the limit, the UE will use a number of slots not exceeding the allowed maximum used slots.

The methods described above may reduce the number of uplink used slots to be in a range less than the number of uplink configured slots. In cases where the number of uplink configured slots is greater than 1, the UE may keep the first part of the uplink configured slots for continuous transmission while leaving the remaining portion of uplink configured slots open for inter-RAT measurement, or for other purposes.

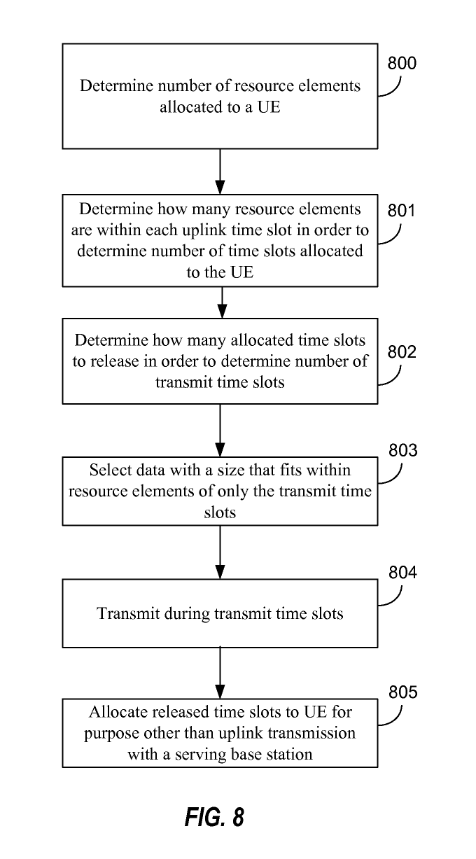

FIG. 8 is a block diagram illustrating gap generation according to one aspect. In block 800 the system determines a number of resource elements allocated to a UE. In block 801 the system determines how many resource elements are within each uplink time slot in order to determine a number of time slots allocated to the UE. In block 802 the system determines how many allocated time slots to release in order to determine a number of transmit time slots. The number of transmit time slots is fewer than the number of allocated time slots. In block 803 the system selects data with a size that fits within resource elements of only the transmit time slots. In block 804 the system transmits during the transmit time slots. In block 805 the system allocates released time slots to the UE for a purpose other than uplink transmission with a serving base station.

In one configuration, the apparatus, such as the UE 350, configured for wireless communication includes means for determining a number of resource elements allocated to a user equipment (UE). The apparatus also includes means for determining how many resource elements are within each uplink time slot in order to determine a number of time slots allocated to the UE. The apparatus further includes means for determining how many allocated time slots to release in order to determine a number of transmit time slots, the number of transmit time slots being fewer than the number of allocated time slots. The apparatus still further includes means for selecting data with a size that fits within resource elements of only the transmit time slots, means for transmitting during the transmit time slots. The apparatus also includes means for allocating released time slots to the UE for a purpose other than uplink transmission with a serving base station.

In one aspect, the aforementioned means may be the antennas 352, the receiver 354, the receive frame processor 360, the channel processor 394, the receive processor 370, the controller/processor 390, and the gap generation module 391 configured to perform the functions recited by the aforementioned means. In another aspect, the aforementioned means may be a module or any apparatus configured to perform the functions recited by the aforementioned means.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining a number of resource elements allocated to a user equipment (UE);
determining how many resource elements are within each uplink time slot in order to determine a number of time slots allocated to the UE;
determining how many allocated time slots to release in order to determine a number of transmit time slots, the number of transmit time slots being fewer than the number of allocated time slots;
selecting data with a size that fits within resource elements of only the transmit time slots;
transmitting during the transmit time slots; and
allocating released time slots to the UE for a purpose other than uplink transmission with a serving base station.

2. The method of claim 1, in which the data size is determined by a transport format combination (TFC).

3. The method of claim 1, further comprising selecting a power level to obtain the selected data size.

4. The method of claim 2, further comprising using only TFCs smaller than a threshold size to obtain the selected data size.

5. The method of claim 1, further comprising performing an inter-radio access technology (RAT) measurement during a period corresponding to the released time slots.

6. The method of claim 1, further comprising performing an inter-frequency measurement during a period corresponding to the released time slots.

7. The method of claim 1 wherein the method is performed in a time division-synchronous code division multiple access (TD-SCDMA) network.

8. A system configured for wireless communication, the system comprising:
means for determining a number of resource elements allocated to a user equipment (UE);
means for determining how many resource elements are within each uplink time slot in order to determine a number of time slots allocated to the UE;
means for determining how many allocated time slots to release in order to determine a number of transmit time slots, the number of transmit time slots being fewer than the number of allocated time slots;
means for selecting data with a size that fits within resource elements of only the transmit time slots;
means for transmitting during the transmit time slots; and
means for allocating released time slots to the UE for a purpose other than uplink transmission with a serving base station.

9. The system of claim 8, in which the data size is determined by a transport format combination (TFC).

10. The system of claim 8 wherein the system is configured for operation in a time division-synchronous code division multiple access (TD-SCDMA) network.

11. A computer program product, comprising:
a computer-readable medium having program code recorded thereon, the program code comprising:
program code to determine a number of resource elements allocated to a user equipment (UE);
program code to determine how many resource elements are within each uplink time slot in order to determine a number of time slots allocated to the UE;
program code to determine how many allocated time slots to release in order to determine a number of transmit time slots, the number of transmit time slots being fewer than the number of allocated time slots;
program code to select data with a size that fits within resource elements of only the transmit time slots;
program code to transmit during the transmit time slots; and
program code to allocate released time slots to the UE for a purpose other than uplink transmission with a serving base station.

12. The computer program product of claim 11, in which the data size is determined by a transport format combination (TFC).

13. The computer program product of claim 11 in which the computer program product is configured for operation in a time division-synchronous code division multiple access (TD-SCDMA) network.

14. An apparatus configured for wireless communication, the apparatus comprising:
at least one processor; and
a memory coupled to the at least one processor, the at least one processor being configured:
to determine a number of resource elements allocated to a user equipment (UE);
to determine how many resource elements are within each uplink time slot in order to determine a number of time slots allocated to the UE;
to determine how many allocated time slots to release in order to determine a number of transmit time slots, the number of transmit time slots being fewer than the number of allocated time slots;
to select data with a size that fits within resource elements of only the transmit time slots;
to transmit during the transmit time slots; and
to allocate released time slots to the UE for a purpose other than uplink transmission with a serving base station.

15. The apparatus of claim 14, in which the data size is determined by a transport format combination (TFC).

16. The apparatus of claim 14, in which the processor is further configured to select a power level to obtain the selected data size.

17. The apparatus of claim 15, in which the processor is further configured to use only TFCs smaller than a threshold size to obtain the selected data size.

18. The apparatus of claim 14, in which the processor is further configured to perform an inter-radio access technology (RAT) measurement during a period corresponding to the released time slots.

19. The apparatus of claim 14, in which the processor is further configured to perform an inter-frequency measurement during a period corresponding to the released time slots.

20. The apparatus of claim 14 in which the apparatus is configured for operation in a time division-synchronous code division multiple access (TD-SCDMA) network.
